(19) United States
(12) Patent Application Publication
(10) Pub. No.: US 2008/0272760 A1
(43) Pub. Date: Nov. 6, 2008

(54) Rechargeable Battery for Connection to a Load

(75) Inventors: Bernd Wiesner, Owen (DE); Jochen Graeber, Bissingen (DE)

Correspondence Address: NORRIS, MCLAUGHLIN & MARCUS, 875 THIRD AVE, 18TH FLOOR, NEW YORK, NY, 10022, US

(73) Assignee: METABOWERKE GMBH, Nuertingen (DE)

(21) Appl. No.: 12/067,252

(22) PCT Filed: Nov. 23, 2005
(86) PCT No.: PCT/EP2005/012513

§ 371 Date: Mar. 18, 2008

(51) Int. Cl. H02J 1/00

(52) U.S. Cl. 323/318

(57) ABSTRACT

The invention relates to a rechargeable battery for connection to a load, in particular for supplying a manually operated electric tool device with electrical energy, comprising a rechargeable-battery housing (28) and rechargeable-battery cells (10) arranged therein and an electronics unit (16), wherein the electronics unit (16) comprises a unit for pulse width modulation for producing different voltages.

The invention relates to a rechargeable battery for connection to a load, in particular for supplying electric power to an electric tool, including a battery housing as well as battery cells arranged in the housing, and an electronic unit.

It is known with conventional electric tools with rechargeable batteries, where the rechargeable batteries are mechanically and electrically connected with the electric tool and thereby supply electric power for driving a tool, to affect an electronic unit by way of a switch disposed on the electric tool, wherein the electronic unit regulates the power of the electric tool through pulse width modulation. These electronic units for power control form here a part of the electric tool.

Conventional electric tools operate at a voltage of 12 V which is supplied by the rechargeable batteries.

More recently, 18 V rechargeable lithium battery packs have been introduced which are used in electric tools and are able to provide increased power levels.

It is an object of the invention to provide a rechargeable battery which makes it possible to use with such tool rechargeable batteries having an individual nominal voltage which is different from the voltage required by the electric tool.

The invention attains this object by employing a rechargeable battery of the aforedescribed type, wherein the electronic unit includes a unit for pulse width modulation to generate different voltage levels.

In this way, rechargeable battery packs, for example 18 V battery packs or rechargeable batteries, can be down-converted to, for example, 12 V which represents the corresponding voltage of the associated electric tool, thereby preventing damage to the rechargeable battery as well as the electric tool. With this approach, newer battery packs providing a higher voltage can be used with older electric tools. Conversely, the newer battery packs can also be used with newer devices at their full output voltage. In this way, electric tools can continue to be utilized or employed.

Certain types of rechargeable batteries, for example lithium ion batteries, which already include an electronic unit for determining and controlling the charge state of the individual battery cells both during charging and discharging, can then advantageously employ already existing components. The already existing electronic unit can also include pulse width modulation for generating different voltage levels, thus obviating the need for additional, separate components which would further limit the already limited space in a battery, for example in batteries used in an electric tool. In addition, such rechargeable batteries should also have the smallest possible weight and the smallest possible dimensions so that they can be easily used with an electric tool or another load, thereby facilitating operation by the user of the load.

In particular, a switch may be provided on the rechargeable battery for setting different voltage levels. Adjustment may be either continuous or in discrete steps. For example, voltages may be adjusted continuously by using a potentiometer. Alternatively, only to discrete voltage levels may be set, for example 12 and 18 V, which represent the conventional voltages for battery-operated loads.

In addition, a first switching element can be disposed on the battery housing and a cooperating second switch element can be disposed on an associated load, wherein the voltage level of the load may be set when the rechargeable battery and load are connected. A user of the load may hence not have to take additional actions. In particular, the position of the switch need not be adjusted by the user, thereby eliminating error sources. In particular, the user of the load can then not forget to adjust the operating voltage, which would otherwise result in errors and/or damage to the rechargeable battery or the electric tool or to another load.

The invention also includes an electric tool which can be mechanically and electrically connected to a rechargeable battery according to one of the preceding claims. Such electric tools, for example impact drills, drilling machines, electric screwdrivers, etc., for the handyman and professionals are increasingly supplied with rechargeable batteries so as to enhance their flexibility during operation and make them independent of an existing power source, in particularly for frequently performed exterior work. Such rechargeable battery-operated devices, which include a rechargeable battery in a battery housing that can be connected to the devise housing of the electric tool, wherein the motor is electrically coupled to the battery pack and also supplied with current while the two housings are connected together, generally include a latching device that couples the two housings together, wherein electric contacts are frequently established in the region of the latching device. An electric tool of this type may also include encoding for a required voltage, which can be recognized by the rechargeable battery when the rechargeable battery is electrically and/or mechanically connected to the tool, so that the pulse width in the rechargeable battery can be set accordingly. In a particularly preferred embodiment, the employed battery cells are lithium-ion cells which provide significantly greater power and a longer lifetime than conventional nickel-cadmium cells.

The invention will now be described in detail with reference to a drawing.

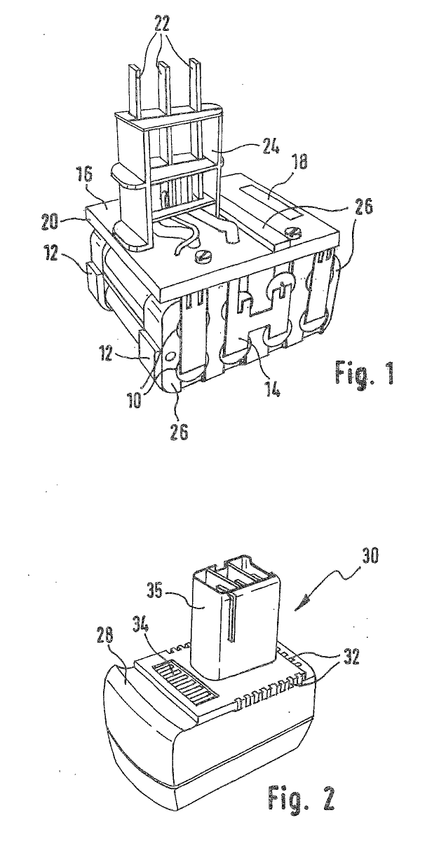

FIG. 1 shows a rechargeable battery pack without housing, and

FIG. 2 shows a rechargeable battery pack.

FIG. 1 shows a rechargeable battery pack without housing with an assembly of several battery cells having the reference symbol 10, a so-called core pack, and the associated electronic unit. The individual battery cells 10 are supported spaced apart by spacers 12, so that the individual battery cells 10 are prevented from contacting each other, thereby preventing short circuits. In the exemplary embodiment, eight battery cells are provided, with the battery cells being connected pairwise in parallel and four parallel connected battery cell pairs being connected in series. Connecting the lithium battery cells 10 in parallel doubles the supplied power. Electronic contact to the battery cells 10 is provided through contact elements 14. The battery cells 10 are then form-fittingly secured on the electronic unit 16 by the support device 12, and the cells are welded together. A test interface 18 is provided for testing the unit after assembly. The test interface 18 is subsequently covered by the battery housing.

The electronic unit 16 for the core pack consisting of battery cells 10 and spacers 12 is molded in a plastic part 20, the so-called electronic cup, and thus protected from the environment. The electronic unit is also a housed in the battery housing (not shown). Only the terminals for connecting the electronic unit to the battery cells 10 protrude from the electronic unit.

A contact system 22 with a three terminals and a digital data port is provided for connecting a battery pack with a battery-operated tool. The contact system is routed in a connecting device 24; the connecting device 24 is subsequently covered by the housing of the battery pack and engages in a corresponding recess of an electric tool.

FIG. 2 shows a rechargeable battery pack, designated overall with the reference symbol 30, with a housing 28 having ventilation slots 32 for incoming air and 34 for discharged air, because the battery pack 30 is air-cooled to increase the lifetime of the battery cells 10. The contact system with the terminals 32 is also completely enclosed is the housing 28 of the battery pack 30, wherein the housing 28 of the battery pack 30 separates and mechanically protects the individual terminals 22. In operation, the battery pack is inserted with the region 35 of the housing into a corresponding receptacle of an electric tool where it is formfittingly secured.

The electronic unit 16, which is arranged in the electronic cup and which includes a corresponding unit, may be used for providing pulse width modulation to regulate the supplied power and/or the applied voltage. Pulse width modulation separates the DC voltage supplied by the rechargeable battery into separate pulses, wherein the individual pulses which have always constant pulse amplitude regulate the supplied power and hence also the applied voltage. The principle of pulse width modulation is known in the art.

By employing a unit for pulse width modulation in the electronic cup, a rechargeable battery pack operating as a lithium battery pack at 18 V can then be down-converted to 12 V and used in a conventional battery-operated 12 V machine, without damaging to the motor of the electric tool. The battery pack may also include a switch (not shown) for switching from 18 V to 12 V or vice versa, wherein actuating the switch causes the pulse width modulation to be controlled and modulated accordingly.

With the aforedescribed approach, power can be controlled quite easily, so that a rechargeable battery can be adapted to different devices.

1-8. (canceled)

9. A rechargeable battery for connection to a load, comprising:
a battery housing,
one or more battery cells arranged in the housing,
an electronic unit comprising a device which generates different voltage levels by way of pulse width modulation, and
a switch disposed on the battery and having a plurality of switch settings, wherein different switch settings cause the electronic unit to supply different voltage levels.

10. The rechargeable battery of claim 9, wherein the load includes a handheld electric tool.

11. The rechargeable battery of claim 9, wherein the switch settings cause the voltage levels to be set continuously.

12. The rechargeable battery of claim 9, wherein the switch settings cause the voltage levels to be set in discrete steps.

13. The rechargeable battery of claim 9, wherein the switch is disposed on the battery housing, said switch cooperating with a switching element disposed on the load, wherein the cooperating switching element sets the switch to a voltage level adapted to the load when the rechargeable battery is connected to the load.

14. The rechargeable battery of claim 9, wherein the one or more battery cells are lithium cells.

15. A handheld electric tool configured for mechanical and electrical connection to a rechargeable battery, the battery comprising
a battery housing,
one or more battery cells arranged in the housing,
an electronic unit comprising a device which generates different voltage levels by way of pulse width modulation, and
a switch disposed on the battery housing and having a plurality of switch settings, wherein different switch settings cause the electronic unit to supply different voltage levels.

16. A handheld electric tool configured for mechanical and electrical connection to a rechargeable battery and including a switching element indicative of an operating voltage of the electric tool, the battery comprising:
a battery housing,
one or more battery cells arranged in the housing,
an electronic unit comprising a device which generates different voltage levels by way of pulse width modulation, and
a switch disposed on the battery housing and cooperating with the switching element disposed on the electric tool, wherein the cooperating switching element sets the switch to a voltage level suitable for operating the electric tool when the rechargeable battery is connected to the electric tool.

17. The handheld electric tool of claim 16, wherein the one or more battery cells are lithium cells.
